(19) United States
(12) Patent Application Publication
(10) Pub. No.: US 2020/0306116 A1
(43) Pub. Date: Oct. 1, 2020

(54) Bed nurse

(71) Applicants: Jessica Lee Platt, Pitcairn, PA (US); James Richard Platt, II, Turtle Creek, PA (US); Rebecca Lynn Nesbitt, Manor, PA (US)

(72) Inventors: Jessica Lee Platt, Pitcairn, PA (US); James Richard Platt, II, Turtle Creek, PA (US); Rebecca Lynn Nesbitt, Manor, PA (US)

(21) Appl. No.: 16/501,356

(22) Filed: Mar. 30, 2019

(51) Int. Cl. A61G 7/10; A61G 7/00; A61G 7/057

(52) U.S. Cl. CPC A61G 7/1021; A61G 7/05769; A61G 7/0005; A61G 7/001

(57) ABSTRACT

The “Bed Nurse” is a pad with 7 inflatable air bladders strategically placed to aide a user/patient or caregiver in moving person from supine to a lifted position in bed. The seven air bladders are placed in the following regions: head/shoulder, upper left torso, upper right torso, waist, upper leg left, upper leg right and lower leg. The air bladders are inflated to varying heights and deflated individually using a small lightweight air compressor with controls. The compressor uses household electric.

The “Bed Nurse” is a bed pad with specific air bladders to be used in raising, lowering, turning, cleaning and dressing a patient or someone in need of care. It will provide access to such person with little or no physical stress to the caregiver.

The “Bed Nurse” has an air compressor with wired remote to specifically shaped and placed air bladders to raise or lower to varying heights.

The “Bed Nurse” has 7 air bladders placed in the following regions: head/shoulder, upper left torso, upper right torso, waist, upper leg left, upper leg right and lower leg. With a wired remote, each air bladder can be raised or lowered individually at the press of a button.

The “Bed Nurse” will benefit the user/patient by providing lift support to all major areas of the body. Using air pressure to targeted areas will aide in healing stiff regions of the body and injuries. Additionally, this can and will act as a stabilizer reducing the risks of falling out of bed. It will keep the patient clean and provide comfort from bed sores and reduce the risk of infections.

The “Bed Nurse” will benefit the caregiver by taking all the manual lifting, pulling and moving away from caregiver duties. It will prevent injuries, loss of work, physical stress and strains. It makes transfer and mobility much easier with less people. The “Bed Nurse” will make changing, cleaning and medical processes easier.

The “Bed Nurse” will benefit many medical fields such as hospitals, personal care homes, assisted living facilities, physical therapists, and rehabilitation professionals to aide in patient mobility improvements, caregivers' proficiency, and patient care.

The “Bed Nurse” will benefit the employer by increasing the proficiency of the staff. It will also reduce the employer's liability with patient injuries, staff injuries and workers compensation claims.

### CROSS-REFERENCE TO RELATED APPLICATIONS

Non-Applicable

### STATEMENT REGARDING FEDERALLY SPONSORED RESEARCH OR DEVELOPMENT (IF APPLICABLE)

Non-Applicable

### REFERENCE TO SEQUENCE LISTING, A TABLE, OR A COMPUTER PROGRAM LISTING COMPACT DISC APPENDIX (IF APPLICABLE)

Non-Applicable

### BACKGROUND OF THE INVENTION

Having family in the medical/caregiver field, we noticed physical problems with moving patients in bed. Many additional problems also stemmed from bed complications for the patient. Some include bed sores, mobility, additional infections as well as stiff joints, patient falls, etc. . . . These caregivers have many challenges along with physical stress and strain. The “Bed Nurse” will alleviate these problems and also aide in patients who may have a variety of injuries (both short and long term), and especially also the elderly who would like to keep their dignity and remain in the home setting for as long as possible.

Currently, there is nothing available to assist the user/patient, the elderly, caregiver or medical provider all in one. Entire adjustable beds are the closest choice and are very costly. Several large apparatuses can be found, but are large, bulky and require many caregivers or assistants. The “Bed Nurse” will not only serve all, but is simple and relatively inexpensive in cost comparison. The “Bed Nurse” is portable, affordable and user-friendly!

### BRIEF SUMMARY OF THE INVENTION

The “Bed Nurse” is a bed pad with specific air bladders to be used in raising, lowering, turning, cleaning and dressing a patient or someone in need of care. It will provide access to such person with little or no physical stress to the caregiver. Specific composition materials, sizes and heights of air bladders will be based on medical specifications and design engineers.

The “Bed Nurse” has an air compressor with wired remote to specifically shaped and placed air bladders to raise or lower to varying heights.

The “Bed Nurse” has 7 air bladders placed in the following regions: head/shoulder, upper left torso, upper right torso, waist, upper leg left, upper leg right and lower leg. With a wired remote, each air bladder can be raised or lowered individually at the press of a button.

The “Bed Nurse” will benefit the user/patient by providing lift support to all major areas of the body. Using air pressure to targeted areas will aide in healing stiff regions of the body and injuries. Additionally, this can and will act as a stabilizer reducing the risks of falling out of bed. It will keep the patient clean and provide comfort from bed sores and reduce the risk of infections.

The “Bed Nurse” will benefit the caregiver by taking all the manual lifting, pulling and moving away from caregiver duties. It will prevent injuries, loss of work, physical stress and strains. The “Bed Nurse” will benefit many medical fields such as physical therapists, and rehabilitation professionals to aide in patient mobility improvements. It makes transfer and mobility much easier with less people. The “Bed Nurse” will make changing, cleaning and medical processes easier.

The “Bed Nurse” will benefit the employer by increasing the proficiency of the staff. It will also reduce the employer's liability with patient injuries, staff injuries and workers compensation claims.

### BRIEF DESCRIPTION OF THE SEVERAL VIEWS OF THE DRAWING

FIG. 1 depicts The “Bed Nurse” in a basic drawing, not to scale.

The thin base pad will lay on a mattress and has 7 inflatable, uniquely designed air bladders strategically placed.

The “Bed Nurse” is operated by an air compressor, plugged into a wall outlet.

The “Bed Nurse” has a wired, diagram remote control coming from the compressor for the user/patient and/or caregiver to operate.

The “Bed Nurse” has side straps and also top and bottom straps. These are to be used by the caregiver/medical professional to transfer a patient lying on The “Bed Nurse” (Ex. One bed to another bed)

The “Bed Nurse” has 4 corner elastic straps to secure to a mattress.

### DETAILED DESCRIPTION OF THE INVENTION

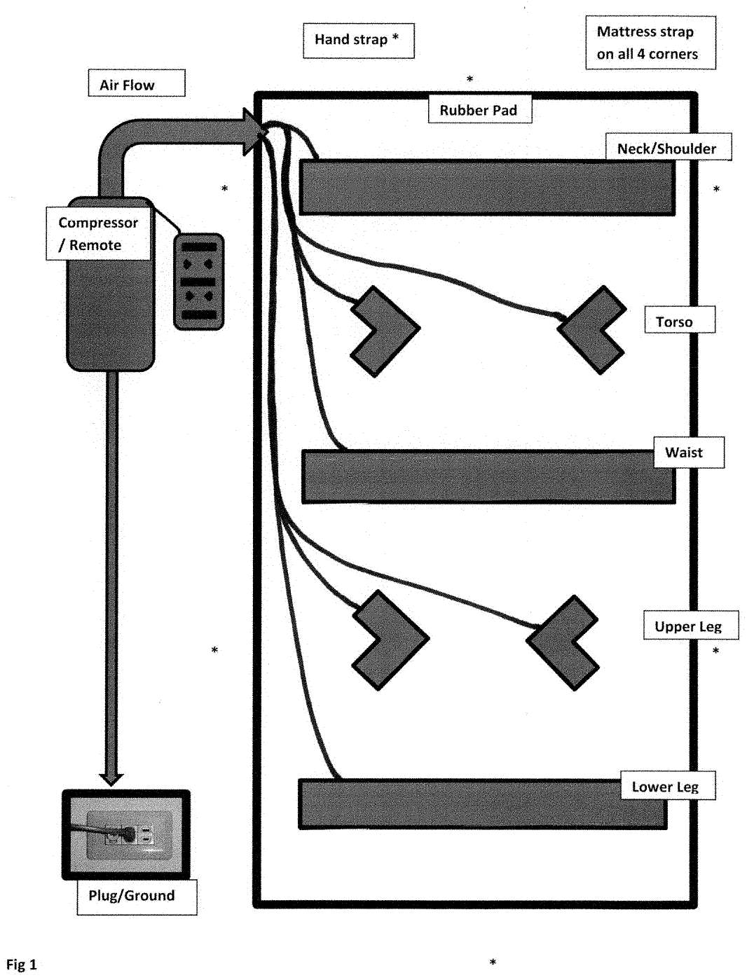

FIG. 1 depicts The “Bed Nurse” in a basic drawing, not to scale.

The thin base pad will lay on a mattress and has 7 inflatable air bladders strategically placed. The seven air bladders are placed in the following regions: head/shoulder, upper left torso, upper right torso, waist, upper leg left, upper leg right and lower leg. Specific composition materials, sizes and heights of air bladders will be based on medical specifications and design engineers.

The “Bed Nurse” is operated by an air compressor, with an undetermined length of electrical cord and a pigtail for a standard wall socket. Individual air lines will come from the compressor, braided in an upper and lower group, to each specific air bladder.

The “Bed Nurse” has a wired, diagram remote control coming from the compressor for the user/patient and/or caregiver to operate.

The “Bed Nurse” has side straps and also top and bottom straps. These are to be used by the caregiver/medical professional to transfer a patient lying on The “Bed Nurse” (Ex. One bed to another bed)

The “Bed Nurse” has 4 corner elastic straps to secure to a mattress.

1. The “Bed Nurse” will aide users/patients with mobility difficulties and caregivers, using strategically placed air bladders to increase or decrease air pressure to specific regions of the body.
a. The “Bed Nurse” will assist user/patients and caregiver to move from supine to a lifted position with little physical strength and stress.
b. The “Bed Nurse” will reduce additional problems with users/patients stemming from bed rest, including but not limited to bed sores, stiff joints, infections, etc. . . . with air pressure.

2. The “Bed Nurse” will benefit medical procedures, including but not limited to cleaning, sanitation, dressing and a vast number of medical processes.

3. The “Bed Nurse” will benefit medical caregivers and medical facilities with less work related injuries, increased productivity with caregivers, patient falls, reduced lawsuits, etc.
a. The “Bed Nurse” will aide staff in the lifting and transferring of patients using hand straps to move from one bed to another.
b. The “Bed Nurse” will benefit many medical fields such as hospitals, personal care homes, assisted living facilities, physical therapists, and rehabilitation professionals to aide in patient mobility improvements, caregivers' proficiency, and patient care.
